(19) United States
(12) Patent Application Publication
(10) Pub. No.: US 2006/0214855 A1
(43) Pub. Date: Sep. 28, 2006

(54) Antenna device and method for manufacturing antenna device

(76) Inventors: Koichi Harada, Tokyo (JP); Tomohiro Suetsuna, Kawasaki-shi (JP); Seiichi Suenaga, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/378,339

(22) Filed: Mar. 20, 2006

(30) Foreign Application Priority Data
Mar. 22, 2005 (JP) 2005-082667

(51) Int. Cl. H01Q 1/38

(52) U.S. Cl. 343/700 MS; 343/895

(57) ABSTRACT

The invention provides a compact and thin antenna device capable of carrying out highly efficient transmission and reception. The antenna device includes an antenna substrate and an antenna arranged directly or in the vicinity of the main face of the antenna substrate. The antenna substrate comprises a plurality of insulating layers mutually layered and bonded, and a plurality of magnetic particles arranged in bonded interfaces of the insulating layers and being embedded in both of the insulating layers of the bonded interfaces.

### CROSS-REFERENCE TO RELATED APPLICATIONS

This application is based upon and claims the benefit of priority from prior Japanese Patent Application No. 2005-082667, filed Mar. 22, 2005, the entire contents of which are incorporated herein by reference.

### BACKGROUND OF THE INVENTION

1. Field of the Invention

The invention relates to an antenna device and a method for manufacturing an antenna device.

2. Description of the Related Art

Along with a sharp increase in communication information, recently, electronic communication appliances are becoming compact and lightweight. Consequently, electronic parts are desired to be compact and lightweight. Existing mobile communication terminals transmit information mainly by transmission and reception of radio waves. The frequency band of the radio waves to be used is a high frequency region of 100 MHz or higher. Therefore, electronic parts and substrates useful in this high frequency region have drawn attention. Further, radio waves in a high frequency region of like gigahertz band has been used for portable mobile communication and satellite communication.

For such radio waves in a high-frequency region, it is required for electronic parts to have low energy loss and transmission loss. For example, with respect to an antenna device indispensable for the mobile communication terminals, transmission loss of the radio waves generated from an antenna is caused during the transmission. The transmission loss is consumed in the form of heat energy in electronic parts and substrates to generate heat in the electronic parts. Further, the transmission loss cancels radio waves to be transmitted to the outside. Therefore, it is needed to transmit intense radio waves and it accordingly hinders efficient use of electric power. Consequently, it is desired to carry out communication with radio waves as low as possible.

Along with pressing needs of miniaturization and lightless, the respective electronic parts tend to be made small and space-saving. However, it is indispensable for an antenna device to retain a distance to electronic parts and substrates so as to suppress transmission loss because of the above-mentioned reasons. Therefore, it cannot help but to keep an unused space, resulting in difficulty of saving space.

For that, an antenna device comprising an insulating substrate (an antenna substrate) of a dielectric ceramic on which an antenna is formed has been developed. The antenna device is enabled to be compact and space-saving. However, the dielectric ceramic has a dielectric loss and therefore, the transmission loss is increased. As a result, high transmission and reception sensitivity cannot be obtained, and the antenna device is therefore currently used as an auxiliary antenna and limited in its power saving property.

An antenna device comprising an insulating substrate with a high permeability as an antenna substrate can draw radio waves from the antenna in the antenna substrate, so that the radio waves can be sent and received without reaching the electronic parts and electronic circuit boards in communication appliances, that is, power saving is made possible. A common highly permeable material is a metal such as Fe or Co, or alloy and oxides thereof. In the case of such a highly permeable material e.g., Fe or Co, the transmission loss due to eddy currents becomes significant when the frequency of radio waves becomes high, so that it is difficult to use such a material as an antenna substrate. On the other hand, in the case where a magnetic material of an insulating oxide represented by ferrites is used for an antenna substrate, the transmission loss due to eddy currents can be suppressed because the magnetic material has a high resistance. However, since resonance frequency of the material may have a high-frequency range of several hundred Hz, the transmission loss due to resonance becomes significant to make the material difficult to use for an antenna substrate. Therefore, as a material for an antenna substrate, it is desired to make available an insulating material with a high permeability, capable of suppressing transmission loss as much as possible, and usable for radio waves of a high frequency.

As a trial of production of such a highly permeable material, a highly permeable nano-granular material is produced by employing a thin film technique such as a sputtering method. However, to carry out this method, a large scale facility is needed. Further, the film thickness of the highly permeable material has to be controlled precisely, and the method is not practical in terms of the cost and yield. Additionally, when the highly permeable material is used for a long duration, agglomeration and grain growth of magnetic particles are promoted to result in deterioration of thermal stability.

Jpn. Pat. Appln. KOKAI Publication No. 2004-281846 discloses a highly permeable material made of a sintered body in form a powder or with a polycrystalline structure containing a hardly reductive metal oxide and metal particles of one or more substances selected from Fe, Co and their alloys.

However, the highly permeable material disclosed in the publication has an isotropic structure with low shape magnetic anisotropy and a relatively low resonance frequency, and therefore, the permeability is decreased in a several gigahertz band. Further, since the highly permeable material is a sintered body of a powder or a polycrystalline structure, agglomeration and grain growth of magnetic particles may possibly be promoted by long time use or oxidation by excess heating just like the highly permeable nano-granular material.

Further, Publication No.: US 2004/0058138 discloses a printed wiring board comprising a substrate, an adhesive layer of a metal oxide formed on the surface of the substrate, and an electromagnetic wave absorbing layer provided on the adhesive layer, wherein the electromagnetic wave absorbing layer has a multilayer structure comprising at least two layers of (a) a magnetic layer containing a plurality of magnetic particles separated from one another by an electrically insulating material and having an average particle diameter of 1 to 150 nm and (b) an electrically insulating layer.

### BRIEF SUMMARY OF THE INVENTION

According to a first aspect of the present invention, there is provided an antenna device, comprising:

an antenna substrate comprising a plurality of insulating layers mutually layered and bonded, and a plurality of magnetic particles arranged in bonded interfaces of the insulating layers and being embedded in both of the insulating layers of the bonded interfaces; and

an antenna arranged directly or in the vicinity of the surface of the antenna substrate.

According to a second aspect of the present invention, there is provided a method for manufacturing an antenna device, comprising:

forming first and second ceramic sheets having mutually different compositions, each of the first and second ceramic sheets containing a compound of at least one metal selected from a group consisting of Mg, Al, Si, Ca, Cr, Ti, Zr, Ba, Sr, Zn, Mn, Hf and rare earth metals (including Y), and at least one of the first and second ceramic green sheets containing a compound of a magnetic metal;

reciprocally laminating a plurality of the first and second ceramic green sheets;

firing the laminated first and second green ceramic sheets to produce first and second ceramic layers; and

precipitating the magnetic metal in the interfaces of the first and second ceramic layers from the ceramic layer containing the oxide of the magnetic metal out of the first and second ceramic layers by subjecting the first and second ceramic layers to reduction treatment.

### BRIEF DESCRIPTION OF THE SEVERAL VIEWS OF THE DRAWING

FIG. 1 is a plane view showing an antenna device according to an embodiment of the invention;

FIG. 2 is a front view showing the antenna device of FIG. 1;

FIG. 3 is an enlarged cross-sectional view showing the antenna substrate of FIG. 1;

FIG. 4 is an enlarged cross-sectional view showing an antenna substrate of an antenna device according to another embodiment of the invention;

FIG. 5 is an enlarged cross-sectional view showing an antenna substrate of an antenna device according to another embodiment of the invention;

FIG. 6 is an enlarged cross-sectional view showing an antenna substrate of an antenna device according to another embodiment of the invention;

FIG. 7 is an enlarged cross-sectional view showing an antenna substrate of an antenna device according to another embodiment of the invention;

FIG. 8 is an enlarged cross-sectional view showing an antenna substrate of an antenna device according to another embodiment of the invention;

FIG. 9 is a cross-sectional view showing an antenna device according to another embodiment of the invention;

FIG. 10 is a cross-sectional view showing an antenna device according to another embodiment of the invention;

FIG. 11 is a cross-sectional view showing an antenna device according to another embodiment of the invention;

FIGS. 12A, 12B, 12C, 12D and 12E are a cross-sectional view showing a process of manufacturing an antenna device according to an embodiment of the invention;

FIG. 13 is an enlarged cross-sectional view of main portions showing a state in which magnetic particles are precipitated in an insulating layer having a porous structure;

FIG. 14 is an enlarged cross-sectional view of main portions showing a state in which an organic resin is injected in the insulating layer having a porous structure after magnetic particle precipitation;

FIG. 15 is a front view showing an electronic circuit board in which an antenna device according to an embodiment of the invention has been assembled;

FIG. 16 is a perspective view showing a mobile phone in which an antenna device according to an embodiment of the invention has been loaded;

FIG. 17 is a front view of FIG. 16;

FIG. 18 is a side view of FIG. 16; and

FIG. 19 is a perspective view of a personal computer in which an antenna device according to an embodiment of the invention has been loaded.

### DETAILED DESCRIPTION OF THE INVENTION

Hereinafter, an antenna device according to an embodiment of the invention will be described in detail.

The antenna device according to the embodiment comprises an antenna substrate comprising a plurality of insulating layers mutually layered and bonded, and a plurality of magnetic particles arranged in bonded interfaces of the insulating layers and being embedded in both of the insulating layers of the bonded interfaces. An antenna is arranged directly in the main face of the antenna substrate or adjacently to the main face of the antenna substrate.

The antenna substrate of such an antenna device has a high permeability while suppressing the transmission loss of radio waves of high frequency of 100 MHz to several GHz which the antenna transmits or receives. Consequently, the radio wave to be transmitted or received by the antenna formed in the antenna substrate is drawn in the above-mentioned antenna substrate with the high permeability. Therefore, in the case where an electronic circuit board is installed together with the antenna device in a communication appliance, absorption of the radio waves in the electronic circuit board is suppressed or prevented, and it becomes possible to carry out highly efficient transmission and reception.

The insulating layer is preferably made of an insulating material having an insulation resistants of 1×10²Ω·cm at a room temperature. Examples of the insulating material include ceramics such as oxide or nitride, organic resin such as polystyrene, polyethylene, polyethylene terephthalate (PET), and epoxy resin, or glass.

Particularly, at least one layer among the plurality of insulating layers is preferably a ceramic layer containing an oxide of at least one metal (M1) selected from the group consisting of Mg, Al, Si, Ca, Cr, Ti, Zr, Ba, Sr, Zn, Mn, Hf, and rare earth metals (including Y). Also, at least one layer of the plurality of insulating layers is preferably a ceramic layer containing an oxide of at least one metal (M1) selected from the group consisting of Mg, Al, Si, Ca, Cr, Ti, Zr, Ba, Sr, Zn, Mn, Hf, and rare earth metals (including Y) and an oxide of a magnetic metal (M2). In the latter ceramic layer, the layer is allowed to contain 0.01 to 0.25% by atom of at least one addition metal (M3) selected from the group consisting of Al, Cr, Sc, Si, Mn and B. The addition metal (M3) is selected to be a different metal from the metal (M1).

At least one layer of the plurality of insulating layers is allowed to be an organic resin layer. The organic resin layer may have morphology in which inorganic material particles are dispersed and contained or a porous morphology in which voids (bubbles) are dispersedly formed.

The magnetic particles are preferably made of at least one magnetic metal selected from the group consisting of Fe, Ni and Co or an alloy containing these magnetic metals.

The antenna is made of, for example, a stainless steel, Ag, Ni, Cu or Au.

Next, the antenna device according to the embodiment will be described more concretely with reference to drawings.

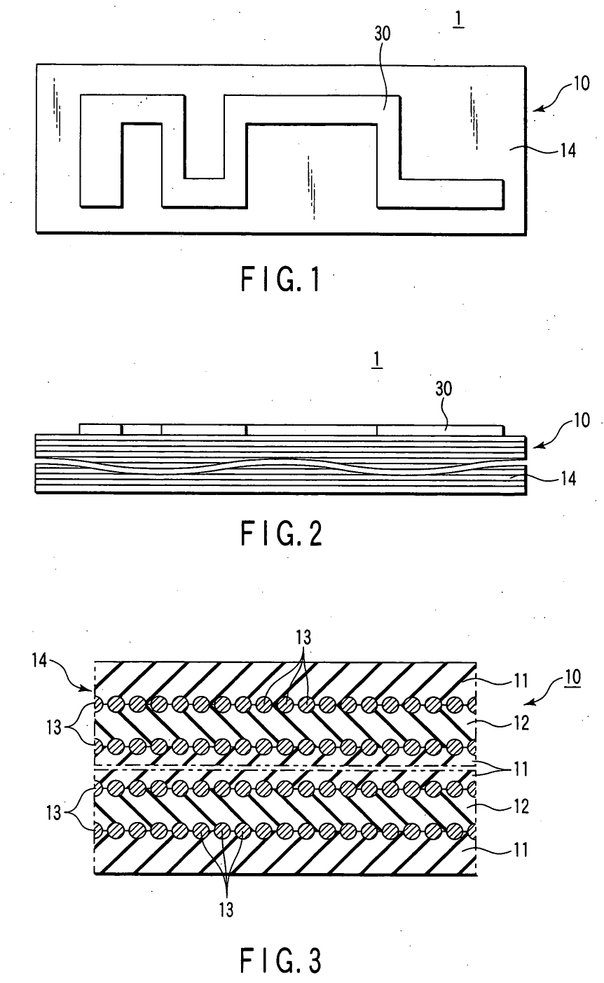

FIG. 1 is a plane view showing an antenna device according to the embodiment, FIG. 2 is a front view of FIG. 1, and FIG. 3 is an enlarged cross-sectional view of FIG. 1.

The antenna device 1 has a structure comprising an antenna substrate 10 and an antenna 30 formed on the substrate as shown in FIGS. 1 and 2.

As shown in FIG. 3, the antenna substrate 10 comprises a layered body 14 formed by reciprocally layering and bonding a first insulating layer 11 and a second insulating layer 12 with different composition from that of the first insulating layer 11 and arranged a plurality of magnetic particles 13 in the bonded interfaces of the insulating layers 11 and 12 in such a manner that the particles are embedded in both of the first and second insulating layers 11 and 12.

The first and second insulating layers 11 and 12 are ceramic layers respectively containing an oxide of at least one metal (M1) selected from the group consisting of Mg, Al, Si, Ca, Cr, Ti, Zr, Ba, Sr, Zn, Mn, Hf, and rare earth metals (including Y) and having mutually different compositions. At least one layer of the ceramic layers to be used for the first and second insulating layers 11 and 12 may contain an oxide of magnetic metal (M2).

The layering combinations of the first and second insulating layers 11 and 12 are exemplified as follows.

(1) The first insulating layer 11: a ceramic is layer containing an oxide of the metal (M1) and the second insulating layer 12: a ceramic layer containing an oxide of the metal (M1) different from the oxide of the first insulating layer 11.

(2) The first insulating layer 11: a ceramic layer containing an oxide of the metal (M1) and the second insulating layer 12: a ceramic layer containing an oxide of the metal (M1) and an oxide of the magnetic metal (M2); in this configuration, the oxide of the metal (M1) contained in the second insulating layer 12 is preferably different from the oxide of the metal (M1) contained in the first insulating layer 11.

(3) The first insulating layer 11: a ceramic layer containing an oxide of the metal (M1) and an oxide of the magnetic metal (M2) and the second insulating layer 12: a ceramic layer containing an oxide of the metal (M1); in this configuration, the oxide of metal (M1) contained in the second insulating layer 12 is preferably different from the oxide of the metal (M1) contained in the first insulating layer 11.

(4) The first insulating layer 11: a ceramic layer containing an oxide of the (M1) and an oxide of the magnetic metal (M2) and the second insulating layer 12: a ceramic layer containing an oxide of the metal (M1) different from the oxide of the first insulating layer 11 and an oxide of the magnetic metal (M2).

In the combinations (1) to (4), assuming that the thermal expansion coefficient of the first insulating layer 11 is denoted as α1 and the thermal expansion coefficient of the second insulating layer 12 is denoted as α2, it is preferable that thermal expansion coefficients satisfy the following inequality: 0.5<α1/α2<2 in a temperature range of 80 to 150° C.

In the combinations (1) to (4), it is preferable that the first insulating layer 11 and the second insulating layer 12 have mutually different dielectric constants, that is, it is preferable that both layers have dielectric constant inclination. Specifically, the first insulating layer 11 contacting the antenna 30 of the antenna device 1 is formed from a ceramic layer containing magnesia (MgO), and the second insulating layer 12 under the layer 11 is formed from a ceramic layer containing alumina (Al₂O₃) so as to have the dielectric constant inclination. An antenna device having a higher transmission and reception efficient to radio waves with a high frequency of 100 MHz to several GHz can be achieved by making such dielectric constant inclination between the first and second insulating layers 11 and 12.

In the combinations (2) to (4), it is preferable that the ceramic layer containing the oxide of the magnetic metal (M2) in addition to the oxide of the metal (M1) is a composite oxide in which the metal (M1) and the magnetic metal (M2) form a solid solution. Specifically, in the case where MgO is used as the oxide of the metal (M1) and FeO is used as the oxide of the magnetic metal (M2), the ceramic layer is preferable to be a Fe—Mg—O type composite oxide. Also, in the case where Al₂O₃ is used as the oxide of the metal (M1) and Fe₂O₃ is used as the oxide of the magnetic metal (M2), the ceramic layer is preferable to be a Fe—Al—O type composite oxide.

In the combinations (2) to (4), at least one of the first and second insulating layers 11 and 12 is configured of the ceramic layer containing the oxide of the magnetic metal (M2) in addition to the oxide of the metal (M1), whereby the oxide of the magnetic metal (M2) can exist among the plurality of magnetic particles 13 arranged in the bonded interfaces of the first and second insulating layers 11, 12. Accordingly, the magnetic coupling property among the magnetic particles 13 can be improved. As a result, even if the intervals of the magnetic particles 13 are made wide, an antenna device 1 comprising the antenna substrate 10 having a higher transmission and reception efficient to radio waves with a high frequency of 100 MHz to several GHz can be achieved.

In the combinations (2) to (4), the ceramic layer containing the oxide of the metal (M1) and the oxide of the magnetic metal (M2) is allowed to contain at least one addition metal (M3) selected from the group consisting of Al, Cr, Sc and Si in an amount of 0.01 to 0.25% by atom. A metal different form the metal (M1) is selected as the addition metal (M3).

The magnetic particles 13 are preferable to be made of at least one magnetic metal selected from the group consisting of Fe, Ni and Co or an alloy containing these magnetic metals. Examples of the magnetic particles 13 include Fe particles, Co particles, Ni particles, Fe—Co particles, Fe—Ni particles, Co—Ni particles, and Fe—Co—Ni particles. In addition, the magnetic particles 13 may be alloyed with another nonmagnetic metal. However, if the nonmagnetic metal is too much, the saturated magnetization is too lowered, and therefore, it is preferable that the alloying with another nonmagnetic metal is 10% by atom or less in terms of high-frequency property. Further, although the nonmagnetic metal may be dispersed alone in the structure, the amount is preferably 20% by volume or less. In terms of the saturated magnetization, the magnetic particles are preferably Fe—Co base particles. The above-mentioned magnetic particles 3 are allowed to form a solid solution with Al or Si as a secondary component at a ratio of 50% by atom or less.

The magnetic particles 13 are preferable to have a particle diameter of 1 to 100 nm. If the particle diameter of the magnetic particles 13 is smaller than 1 nm, the super paramagnetism may be possibly caused to result in decrease of saturated magnetic flux density. On the other hand, if the particle diameter of the magnetic particles 13 exceeds 100 nm, eddy current loss is generated to make it difficult to retain the characteristics as the antenna substrate 10. Also, if the particle diameter exceeds 100 nm, a multi-magnetic domain structure tends to be formed owing to energy stability. The high frequency property of the permeability of the multi-magnetic domain structure may be possibly degraded more than the high frequency property of the permeability of a mono-magnetic domain structure. Particularly, in terms of retainment of the mono-magnetic domain structure, the upper limit of the particle diameter of the magnetic particles 13 is more preferably 50 nm. The magnetic particles 13 are even more preferable to have a particle diameter of 10 to 50 nm.

In the form of which the plurality of magnetic particles 13 having a particle diameter within the above-mentioned range are arranged in the bonded interfaces of the first and second insulating layers 11 and 12, the thickness of the first and second insulating layers 11 and 12 is preferably 0.05 to 100 μm, more preferably 0.05 to 1 μm on the assumption that the thickness is at least twice as thick as the diameter of the magnetic particles. The antenna substrate 10 comprising such thin first and second insulating layers 11 and 12 has a higher transmission and reception efficient to radio waves with a high frequency of 100 MHz to several GHz in relation to the particle diameter of the magnetic particles 13. The first and second insulating layers 11 and 12 with such thickness are preferably layered in 100 or more layers, more preferably 500 to 2000 layers.

In the form of which the plurality of magnetic particles 13 having a particle diameter in the above-mentioned range are arranged in the bonded interfaces of the first and second insulating layers 11 and 12, the distance among the magnetic particles 13 is preferably 10 nm or narrower. Arrangement of the plurality of magnetic particles 13 in the bonded interfaces of the first and second insulating layers 11 and 12 at a distance of 10 nm or narrower improves the magnetic coupling property among the magnetic particles 13, and it becomes possible to achieve an antenna device 1 comprising the antenna substrate 10 having a higher transmission and reception efficient to radio waves with a high frequency of 100 MHz to several GHz. The distance among the magnetic particles 13 is more preferably 5 nm or narrower. In the case where at least one of the first and second insulating layers 11 and 12 contains the oxide of the magnetic metal (M2), the magnetic coupling property among the magnetic particles 13 can be sufficiently improved even if the distance among the magnetic particles 13 is adjusted to be about 50 nm.

The plurality of magnetic particles 13 are preferable to have crystallinity like a single crystal or polycrystalline, and the crystal orientation of the magnetic particles 13 is preferable to be parallel in two or more axes to the crystal orientation of particles constituting at least one insulating layer of the first and second insulating layers 11 and 12. Such an orientation (lattice conformity) is easily achieved by forming the ceramic layer containing the oxide of the metal (M1) for the first and second insulating layers 11 and 12. The magnetic particles 13 can exist in the interface between the first and second insulating layers 11 and 12 in further thermally stabilized state by providing a predetermined lattice conformity between the plurality of magnetic particles 13 and at least one layer of the first and second insulating layers 11 and 12. Consequently, an antenna device 1 comprising the antenna substrate 10 capable of extended use can be made available.

The above-mentioned oriented magnetic particles are allowed to exist not only in the interface of the insulating layer but also in the inside of the insulating layer in either a case where single particles constituting the insulating layer are oriented or a case where the insulating layer is a single crystal. In such a state, the crystal orientation directions of groups of the oriented magnetic particles can further be made even.

The insulating layer is preferable to be oriented entirely in parallel to the insulating layer and in the same direction. Accordingly, the precipitated magnetic particles also have anisotropy in the plane parallel to the insulating layer. Consequently, it is preferable for the insulating layer that the easy magnetization axes of the magnetic particles to be precipitated are oriented so as to be in parallel direction to the layer.

Practically, in the case where the magnetic particles are cubic Ni particles, the Ni particles are preferable to be oriented in the [111] direction parallel to the insulating layer. In the case where the magnetic particles are hexagonal Co particles, the Co particles are preferable to be oriented in the [001] direction. In the case where the magnetic particles are Fe particles, the Fe particles are preferable to be oriented in the [100] direction.

For example, Ni particles, which are magnetic particles, are to be precipitated in a MgO type solid solution (an insulating layer), it is made possible to orient and precipitate the Ni particles also in the same direction by orienting the MgO solid solution in the [111] direction. Also in the case where Co is to be precipitated in a MgO type solid solution (an insulating layer), it is made possible to orient and precipitate Co also in the same direction by orienting the MgO solid solution in the [111] direction. In this case, with respect to Co, the face-centered cubic Co, which is a higher temperature phase, can be precipitated by selecting the reduction temperature and the cooling speed. In this case, the lattice conformity of Co particles with respect to MgO solid solution is made excellent by the hexagonal Co.

To orient the above-mentioned insulating layer, a method of making a sheet using insulator particles having even shape anisotropy and crystal anisotropy can be employed. As a measurement method of anisotropy, x-ray diffractometry and electron beam diffractometry using a transmission electron microscope can be exemplified. In the case of the x-ray diffractometry, measurement is carried out for the insulating layer in the vertical direction (the layering direction) and the parallel direction to evaluate the anisotropy based on the intensity ratio of the oriented peak and other peaks. That is, for example, in the [111] direction of Ni, the anisotropy can be expressed by the ratio (I_{[111]}/[I_{[111]}+Iₒₜₕₑᵣ]) of the intensity (I_{[111]}) and other intensity (Iₒₜₕₑᵣ) in the (111) plane. The ratio is better if the value is higher and it is preferable that the intensity ratio is 80% or higher.

Further, the oriented precipitation of the magnetic particles is facilitated by using an insulating layer of a single crystal. The insulating layer of a single crystal makes it possible to crystallize an insulating layer to be formed thereon by using the single crystal as a seed crystal if the insulating layer of a single crystal is used as the undermost layer.

With such a constitution, the density of the magnetic particles in the antenna substrate is increased and the magnetization per unit volume can be increased and accordingly it is made possible to make the antenna substrate thin.

The formation in which the plurality of magnetic particles 13 are embedded with the predetermined orientation in the interface between the first and second insulating layers 11 and 12 is different from that in which the magnetic particles are embedded simply in dents of the surface of insulating layers, and can be distinguished based on the difference in TEM, diffraction image, and the like.

The antenna 30 is made of, for example, Ag, Ni, Cu, Au, or the like and may have a thickness of 15 to 100 μm.

As described above, in the antenna substrate comprising the first and second insulating layers 11 and 12 made of ceramic layers with mutually different compositions each containing at least one oxide of the metal (M1) selected from the group consisting of Mg, Al, Si, Ca, Cr, Ti, Zr, Ba, Sr, Zn, Mn, Hf and rare earth metals (including Y) as shown in FIGS. 1 to 3, it is made possible for the magnetic particles 13 to exist in the thermally stabilized state in the interface between the first and second insulating layers 11 and 12. Consequently, in the case where an electronic circuit board is disposed together with the antenna device in the communication appliance described above, the radio wave absorption in the electronic circuit board can be suppressed or prevented for a long duration, and it is made possible to provide the antenna device 1 comprising the antenna substrate 10 capable of carrying out highly efficient transmission and reception more stably.

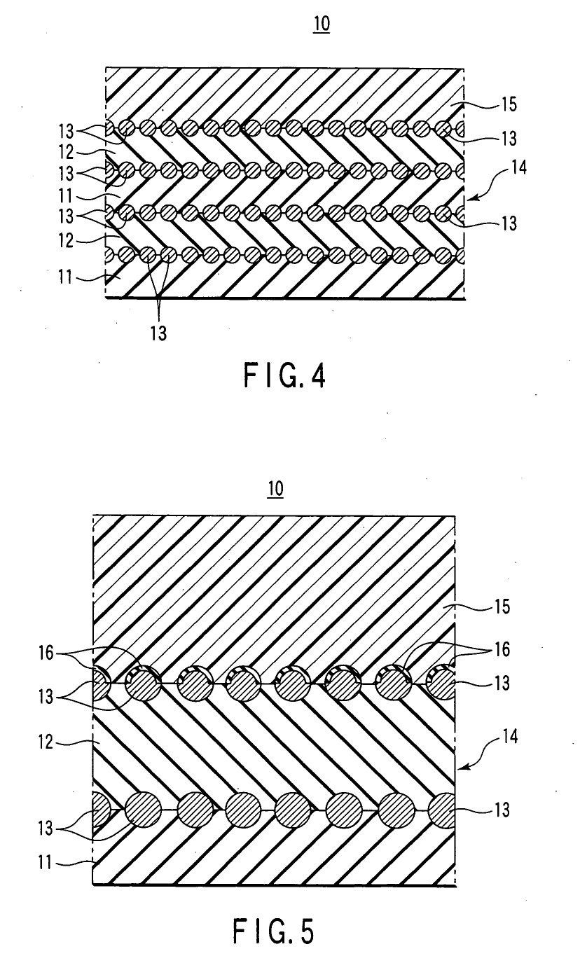

FIG. 4 is an enlarged cross-sectional view showing main portions of an antenna substrate of an antenna device according to another embodiment of the invention. In FIG. 4, the same symbols are assigned to the members same as those in FIG. 3, and their explanation is omitted.

The antenna substrate 10 comprises an organic resin layer 15 formed on the second insulating layer 12 in the surface of the layered body 14. The plurality of magnetic particles 13 are arranged in the bonded interface between the second insulating layer 12 and the organic resin layer 15 in such a manner that the particles are embedded in both of the second insulating layer 12 and the organic resin layer 15. An antenna (not shown) is formed on the organic resin layer 15 of the antenna substrate 10. The magnetic particles 13 to be arranged in the bonded interface between the second insulating layer 12 and the organic resin layer 15 can be formed by forming, as a ceramic layer existing in the outermost surface of the layered body 14, a composition containing the oxide of the magnetic metal (M2) in addition to the oxide of the metal (M1), and precipitating the magnetic metal also from the ceramic layer at the time of reduction treatment in a production method, which will be described later.

As the above-mentioned organic resin, polystyrene, polyethylene, polyethylene terephthalate (PET), epoxy resin, or the like can be exemplified.

The antenna substrate 10 with the configuration shown in FIG. 4 is provided with dielectric constant inclination between the second insulating layer 12 made of a ceramic layer positioned in the uppermost layer of the layered body 14 and the organic resin layer 15. Accordingly, the antenna device comprising the above-mentioned antenna substrate 10 has a higher transmission and reception efficiency to radio waves with a high frequency of 100 MHz to several GHz. Further, it is made possible to obtain an antenna device with improved durability to the physical load such as vibration by forming the organic resin layer 15 as the surface of the antenna substrate 10 on which an antenna is to be formed. Moreover, use of the organic resin layer 15 as an insulating layer makes the antenna substrate 10 lightweight as compared with the case the insulating layers are solely ceramic layers.

The plurality of magnetic particles 13 arranged in the interface between the second insulating layer 12 and the organic resin layer 15 are preferable to be coated in the surface to be embedded in the organic resin layer 15 with a film 16 made of at least one inorganic material selected from the group consisting of Al₂O₃, AlN, SiO₂, Si₃N₄ and SiC, as shown in FIG. 5. With such a structure, the adhesion of the magnetic particles 13 and the organic resin layer 15 can be improved. In this case, the material of the film 16 is selected to be different from an oxide of at least one metal (M1) selected from the group consisting of Mg, Al, Si, Ca, Cr, Ti, Zr, Ba, Sr, Zn, Mn, Hf and rare earth metals (including Y) composing the second insulating layer 12 neighboring the organic resin layer 15.

The thickness of the film 16 is preferable to be 1 to 5 nm independently of the particle diameter of the magnetic particles 13. The magnetic particles 13 having the film 6 with such a thickness maintains the high resistance of the antenna substrate 10 in addition to the adhesion improvement.

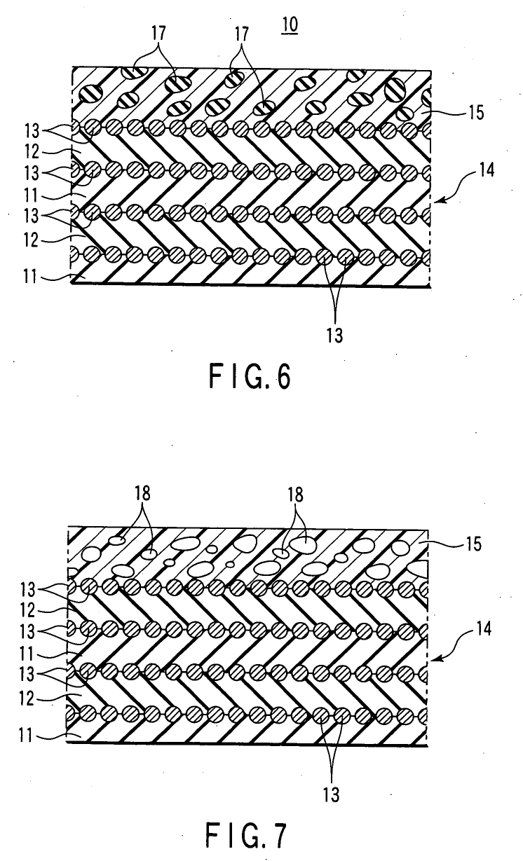

FIG. 6 is an enlarged cross-sectional view showing an antenna substrate of an antenna device according to another embodiment. In FIG. 6, the same symbols are assigned to the members same as those in FIG. 3 and their explanation is omitted.

The antenna substrate 10 comprises an organic resin layer 15 containing a large number of inorganic material particles 17 dispersed therein on the second insulating layer 12 on the surface of the layered body 14. A plurality of magnetic particles 13 are arranged in the bonded interface of the second insulating layer 12 and the organic resin layer 15 in such a manner that the particles are embedded in both of the second insulating layer 12 and the organic resin layer 15. An antenna (not shown) is formed on the organic resin layer 15 of the antenna substrate 10. The above-mentioned magnetic particles 13 to be arranged in the bonded interface of the second insulating layer 12 and the organic resin layer 15 can be formed by the same method as described for the antenna substrate shown in FIG. 4.

Similarly to the exemplification above, examples of the above-mentioned organic resin include polystyrene, polyethylene, polyethylene terephthalate (PET) and epoxy resin.

Examples of the inorganic material include ceramics such as Al₂O₃, MgO, Zno. Assuming that the thickness of the organic resin layer 15 is 0.05 to 1000 μm, the inorganic material particles 17 are preferable to have an average particle diameter of 10 to 1000 nm. The inorganic material particles 17 having such an average particle diameter are preferable to be dispersed in a ratio of 20 to 90% by volume in the organic resin layer 15.

The antenna substrate 10 with the configuration shown in FIG. 6 is provided with dielectric constant inclination between the second insulating layer 12 made of a ceramic layer positioned in the uppermost layer of the layered body 14 and the organic resin layer 15. Also, the dielectric constant of the organic resin layer 15 can be controlled by adjusting the dispersion amount of the inorganic material particles 17 dispersed in the organic resin layer 15. Accordingly, the antenna device comprising the antenna substrate 10 has a higher transmission and reception efficiency to radio waves with a high frequency of 100 MHz to several GHz. In addition, it is made possible to obtain an antenna device with improved durability to the physical load such as vibration by forming the organic resin layer 15 as the surface of the antenna substrate 10 on which an antenna is to be formed.

FIG. 7 is a magnified cross-sectional view showing an antenna substrate of an antenna device according to another embodiment. In FIG. 7, the same symbols are assigned to the members same as those in FIG. 3 and their explanation is omitted.

The antenna substrate 10 comprises an organic resin layer 15 containing a large number of foams 18 dispersed therein on the second insulating layer 12 on the surface of the layered body 14. A plurality of magnetic particles 13 are arranged in the bonded interface of the second insulating layer 12 and the organic resin layer 15 in such a manner that the particles are embedded in both of the second insulating layer 12 and the organic resin layer 15. An antenna (not shown) is formed on the organic resin layer 15 of the antenna substrate 10. The above-mentioned magnetic particles 13 to be arranged in the bonded interface of the second insulating layer 12 and the organic resin layer 15 can be formed by the same method as described for the antenna substrate shown in FIG. 4.

Similarly to the exemplification above, examples of the organic resin, polystyrene includes polyethylene, polyethylene terephthalate (PET) and epoxy resin.

Assuming that the thickness of the organic resin layer 15 is 0.05 to 1000 μm, the foams 18 are preferable to have an average particle diameter of 10 to 1000 nm. The foams 18 having such an average particle diameter are preferable to be dispersed in a ratio of 5 to 50% by volume in the organic resin layer 15.

The antenna substrate 10 with the configuration shown in FIG. 7 is provided with dielectric constant inclination between the second insulating layer 12 made of a ceramic layer positioned in the uppermost layer of the layered body 14 and the organic resin layer 15. Also, the dielectric constant of the organic resin layer 15 can be controlled by adjusting the dispersion amount of the foams 18 dispersed in the organic resin layer 15. Accordingly, the antenna device comprising the antenna substrate 10 has a higher transmission and reception efficiency to radio waves with a high frequency of 100 MHz to several GHz. Also, it is made possible to obtain an antenna device with improved durability to the physical load such as vibration by forming the organic resin layer 15 as the surface of the antenna substrate 10 on which an antenna is to be formed. Moreover, use of the organic resin layer 15 in which the foams 18 are dispersed as the insulating layer makes the antenna substrate 10 more lightweight than that in the case where the insulating layer is made of solely a ceramic layer.

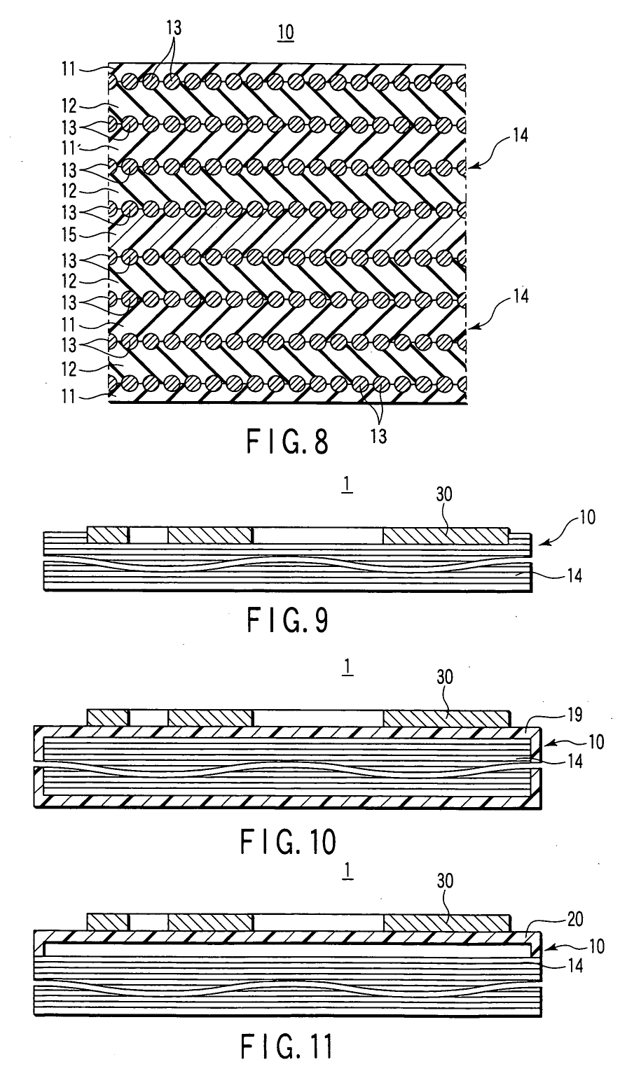

FIG. 8 is a magnified cross-sectional view showing an antenna substrate of an antenna device according to another embodiment. In FIG. 8, the same symbols are assigned to the members same as those in FIG. 3 and their explanation is omitted.

The antenna substrate 10 comprises an organic resin layer 15 inserted between two layered bodies 14. A plurality of magnetic particles 13 are arranged in the bonded interface of the second insulating layer 12 and the organic resin layer 15 of one layered body 14 and in the bonded interface of the second insulating layer 12 and the organic resin layer 15 of the other layered body 14 in such a manner that the particles are embedded in both of the second insulating layers 12 and the organic resin layers 15. An antenna (not illustrated) is formed on the surface of one layered body 14 of the antenna substrate 10. The magnetic particles 13 to be arranged in the respective bonded interfaces of the second insulating layers 12 and the organic resin layers 15 of the two layered bodies 14 can be formed by the same method as described for the antenna substrate shown in FIG. 4.

Similarly to the exemplification above, examples of the organic resin include polystyrene, polyethylene, polyethylene terephthalate (PET) and epoxy resin.

In the antenna substrate 10 with the configuration shown in FIG. 8, the strength is improved and the dielectric constant can be controlled by the organic resin layer 15 inserted in the middle.

In the antenna substrate 10 shown in FIGS. 4 to 8, the plurality of magnetic particles 13 to be arranged in the bonded interface of the second insulating layer 12 and the organic resin layer 15 are preferable to have a particle diameter preferably in a range of 1 to 100 nm, and more preferably in a range of 10 to 50 nm as described above, and the distance among the magnetic particles 13 is preferably 10 nm or narrower. In addition, it is desirable for the plurality of magnetic particles 13 to have crystallinity like a single crystal or polycrystalline and also to have the crystal orientation parallel in two or more axes to the crystal orientation of the second insulating layer 12.

The organic resin layer 15 of the antenna substrate 10 shown in FIG. 8 may have inorganic material particles or foams dispersed therein, as shown in FIGS. 6 and 7.

Next, an antenna device according to another embodiment will be described with reference to FIGS. 9 to 11.

An antenna device 1 shown in FIG. 9 has a structure comprising the antenna substrate 10 shown in FIG. 3 in which the antenna 30 is embedded.

With such a structure shown in FIG. 9, since the antenna 30 is embedded in the antenna substrate 10, the retainability of the antenna 30 in relation to the antenna substrate can be improved.

The antenna device 1 shown in FIG. 10, for example, comprises: an antenna substrate 10 obtained by covering the outer circumferential face of the layered body 14 shown in FIG. 3 with an exterior resin layer 19; and an antenna 30 formed in the exterior resin layer 19 of the antenna substrate 10. The exterior resin layer 19 is made of, for example, polystyrene, polyethylene, polyethylene terephthalate (PET), and epoxy resin.

With the configuration shown in FIG. 10, the antenna device comprises the antenna substrate 10 having the layered body 14 coated with the exterior resin layer 19 showing buffering function against impacts. Accordingly, the device is provided with excellent durability to the impacts as compared with the case where the antenna substrate is composed of only the layered body 14 formed by layering the first and second insulating layers of ceramics containing the oxide of the metal (M1), which is relatively weak to impacts. Further, since the antenna substrate 10 has a high barrier property to water owing to the exterior resin layer 19, the materialized antenna device 1 is provided with long term durability.

An antenna device 1 shown in FIG. 11, for example, comprises the antenna substrate 10 shown in FIG. 3, a box type organic resin spacer 20 formed on the antenna substrate 10 and having an opening in the lower part, and the antenna 30 formed on the spacer 20. The organic resin spacer 20 is made of, for example, polystyrene, polyethylene, polyethylene terephthalate (PET), and epoxy resin.

With such a structure shown in FIG. 11, the drawing degree of radio waves by the antenna substrate. 10 can be controlled corresponding to the frequency of the radio waves from the antenna 30 by adjusting the height of the spacer 20 on which the antenna 30 is to be formed. Consequently, in the case where an electronic circuit board is disposed together with the antenna device 1 in a communication appliance, absorption of the radio wave in the electronic circuit board is properly prevented, and thus, highly efficient transmission and reception can be carried out.

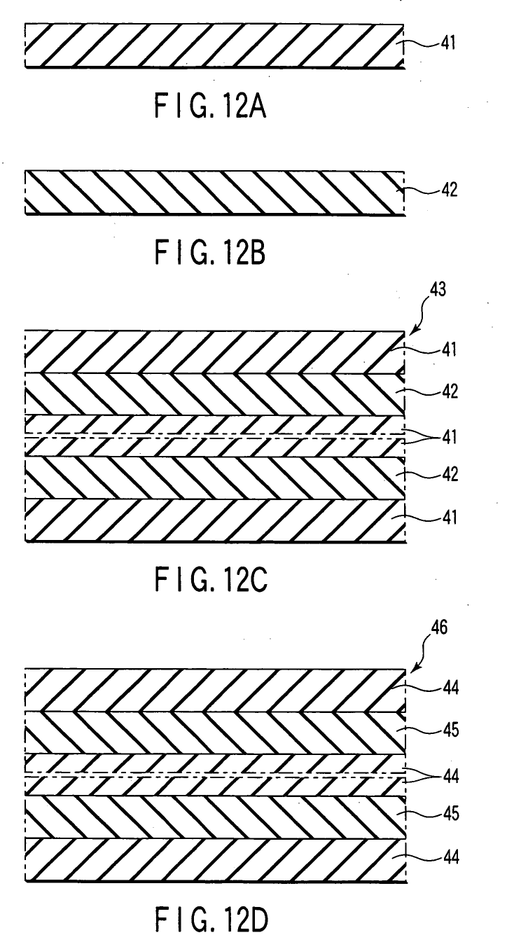

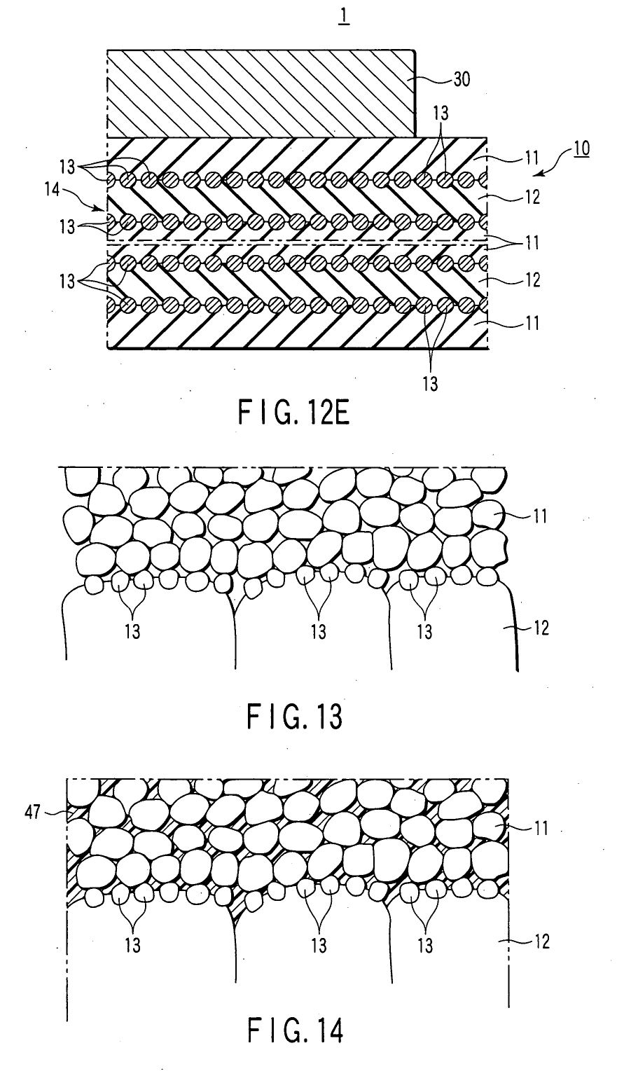

Next, a method for manufacturing the antenna device according to the embodiment will be described in detail with reference to FIGS. 12A to 12E.

(First Process)

First, first and second ceramic green sheets which contain a compound of at least one metal (M1) selected from a group consisting of Mg, Al, Si, Ca, Cr, Ti, Zr, Ba, Sr, Zn, Mn, Hf and rare earth metals (including Y) and have mutually different compositions and of which at least one contains a compound of magnetic metal (M2) such as Fe, Co, and Ni are formed.

More specifically, a raw material is prepared by adding a binder such as polyvinyl alcohol (PVA) to the compound of the metal (M1) and evenly mixing the mixture by a ball mill comprising balls made of a resin such as nylon and a pot. The raw material is formed into a sheet to manufacture a first ceramic green sheet 41 containing the compound of the metal (M1) as shown in FIG. 12A.

Also, a raw material is prepared by adding a binder such as polyvinyl alcohol (PVA) to the compound of the metal (M1) and the compound of the magnetic metal (M2) and evenly mixing the mixture by a ball mill. The raw material is formed into a sheet to manufacture a second ceramic green sheet 42 containing the compound of the metal (M1) and the compound of the magnetic metal (M2) as shown in FIG. 12B.

(Second Process)

The plurality of first and second ceramic green sheets are reciprocally layered to manufacture a ceramic green sheet layered body. Specifically, as shown in FIG. 12C, the plurality of first and second ceramic green sheets 41 and 42 are reciprocally layered in such a manner that the first green sheet 41 containing no compound of the magnetic metal (M2) exists in the uppermost and the lowest layers to manufacture a ceramic green sheet layered body 43 as shown in FIG. 12C.

(Third Process)

The ceramic green sheet layered body 43 is degreased and fired to manufacture a fired layered body 46 in which the plurality of first and second ceramic layers 44 and 45 are reciprocally layered and bonded as shown in FIG. 12D.

(Fourth Process)

The fired layered body 46 is subjected to reducing treatment to precipitate a magnetic metal from the oxide of the magnetic metal (M2) contained in the second ceramic layer 45 in the interface between the first and second ceramic layers 44 and 45. Such reducing treatment produces an antenna substrate 10 of a layered body 14 in which the first insulating layer 11 composed of the first ceramic layer containing the oxide of at least one metal (M1) selected from the group consisting of Mg, Al, Si, Ca, Cr, Ti, Zr, Ba, Sr, Zn, Mn, Hf and rare earth metals (including Y), and the second insulating layer 12 of a composition different from that of the first insulating layer 11 are reciprocally layered and bonded and a plurality of magnetic particles 13 are arranged in the bonded interfaces of the first and second insulating layers 11 and 12 in such a manner that the particles are embedded in both of the first and second insulating layers. The composition of the second insulating layer 12 is changed to have a decreased amount of the oxide of the magnetic metal (M2) as compared with that of the second ceramic layer 45 corresponding to the precipitation amount of the magnetic metal (M2) or to contain no oxide of the magnetic metal (M2). Thereafter, an antenna 30 is formed on the first insulating layer 11 in the uppermost of the antenna substrate 10 to manufacture an antenna device 1.

In the above-mentioned first step, examples of the compound of the metal (M1) and the compound of the magnetic metal (M2) contained in the respective ceramic green sheets 41 and 42 include an oxide, a hydroxide and a carbonate. Among them, oxides are preferable.

The second ceramic green sheet is preferable to contain the oxide of the magnetic metal (M2) including at least one selected from the group consisting of Fe, Co and Ni in form of a composite oxide which is a solid solution with the oxide of the metal (M1). As the oxide of the magnetic metal (M2), ferrous oxide (FeO), cobalt oxide (CoO), and nickel oxide (NiO) are preferable because they easily form a solid solution with the oxide of the metal (M1) to prepare the composite oxide. Examples of the iron oxide include FeO, Fe₂O₃, and Fe₃O₄, and ferrous oxide (FeO) is preferable because it easily forms a solid solution with the oxide of the metal (M1) to prepare the composite oxide. For example, in the case where, for example, MgO is used as the oxide of the metal (M1) and FeO is used as the oxide of magnetic metal (M2), the MgO and FeO are reacted to manufacture a composite oxide in a full solid-solution state (a Fe—Mg—O type solid solution). On the other hand, in the case where Al₂O₃ is used as the oxide of the metal (M1) and Fe₂O₃ is used as the oxide of the magnetic metal (M2), the Al₂O₃ and Fe₂O₃ are reacted to manufacture a composite oxide in a full solid-solution state (Fe—Al—O). Additionally, the second ceramic green sheet may further contain an oxide of iron with different valency other than FeO or Fe₂O₃ as the iron oxide.

As described above, use of the second ceramic green sheet 42 containing the composite oxide makes it easy to precipitate magnetic metal in the composite oxide in the interface between the first and second ceramic layers 44 and 45 by the reducing treatment in the fourth process. It is made also possible to easily precipitate fine magnetic particles 13 in the interface between the first and second ceramic layers 44 and 45. Further, is it made possible to make the precipitated magnetic particles have crystal orientation parallel in two or more axes to the crystal orientation of the second ceramic layer 45 (the second insulating layer 12). Furthermore, it is made possible that the magnetic particles 13 having a particle diameter of 1 to 100 nm are precipitated in the interface between the first and second insulating layers 11 and 12 at a distance of 50 nm or narrower from one another.

In the case where the metal (M1) and the magnetic metal (M2) are contained in form of a composite oxide in the second ceramic green sheet 42, the oxide of the metal (M1) and the oxide of the magnetic metal (M2) are preferable to be added at a ratio a:b in a range of 10:90 to 90:10 wherein “a” denotes the ratio by mole of the oxide of the metal (M1) and b denotes the ratio by mole of the oxide of the magnetic metal (M2). In the composite oxide, if the ratio of the oxide of the magnetic metal (M2) is higher than a:b=10:90, the crystal particles of the magnetic particles precipitated in the reduction process become so large as to possibly degrade the high frequency properties as the antenna substrate. On the other hand, if the ratio of the oxide of the metal (M1) is higher than a:b=90:10 in the composite oxide, that is the ratio of the oxide of the magnetic metal (M2) is lower, the number of the magnetic particles 13 to be precipitated in the reduction process is decreased to result in possible deterioration of magnetic interaction among the magnetic particles. Further, in some cases, since precipitation particles becomes diameter of less than 1 nm, super paramagnetism may be possibly caused to result in deterioration of the properties. The ratio a:b is more preferably 20:80 to 50:50.

In the case where MgO as the oxide of the metal (M1) and FeO as the oxide of magnetic metal (M2) are contained in form of a composite oxide in the second ceramic green sheet 42, the composite oxide in the Mg—Fe—O type full solid solution state can easily be produced by reaction of MgO and FeO at a ratio of e.g., 2:1 by mole. Use of the second ceramic green sheet containing such a composite oxide makes it possible to properly control the amount of the magnetic particles 13 to be precipitated in the interface between the first and second ceramic layers 44 and 45 in the reduction treatment in the fourth process and to suppress agglomeration and grain growth of the magnetic particles 13.

As the oxide of the magnetic metal (M2), it is allowed for the oxide to exist in form of not only a single oxide but also a composite oxide such as CoFe₂O₄ and NiFe₂O₄ in the second ceramic green sheet 42. Particularly, in the case where the composite oxide is formed by selecting oxides of Ni and at least one of Fe and Co, the amount of Ni is preferable to be controlled at 50% by mole or lower to the amount of Co and/or Fe.

In the first process, the second ceramic green sheet 42 containing the compound of the magnetic metal (M2), preferably the composite oxide of the metal (M1) and the magnetic metal (M2) is preferable to further contain at least one addition metal (M3) selected from the group consisting of Al, Cr, Sc, Si, Mn and B for promoting the precipitation of the magnetic particles at the time of the reduction treatment. The addition metal (M3) is selected to be a metal different from the metal (M1). The addition metal (M3) is preferable to be contained in a range of 0.01 to 0.25% by atom in the insulating layer (oxide) after the firing treatment.

In the first process, the second ceramic green sheet 42 containing the compound of the magnetic metal (M2) is allowed to further contain Cu or Mn.

In the second process, depending on the thickness of the first and second ceramic green sheets 41 and 42, it is preferable to laminate the sheets in about 100 layers or more.

In the third process, when the first and second ceramic green sheet 41 and 42 are produced from raw materials of oxides, it is preferable to carry out the firing at 1000° C. or higher in oxidizing atmosphere, vacuum, or inert atmosphere of such as argon. On the other hand, when the first and second ceramic green sheet 41 and 42 are produced from raw materials other than oxides, it is preferable to carry out the firing at 1000° C. or higher in oxidizing atmosphere. The oxidizing atmosphere means atmospheric air and oxygen-containing inert gas atmosphere. In the case where the first and second ceramic green sheet 41 and 42 are produced from raw materials of oxides, it is preferable to carry out the firing in inert atmosphere or vacuum. For example, in the case of using the second ceramic green sheet 42 containing the composite oxide of the metal (M1) and the magnetic metal (M2), it is preferable that the firing process is carried out in vacuum or Ar atmosphere.

In the fourth process, the reduction treatment is carried out by using a reducing gas such as hydrogen, carbon monoxide or methane, and hydrogen is particularly preferable. The temperature for the reduction treatment with hydrogen is not particularly limited as long as it is sufficient to reduce a part of the oxide in the second ceramic layer 45 composing the fired layered body 46, and it is preferably 200 to 1500° C. If the reduction temperature is lower than 200° C., the reduction reaction is slow down to result in decrease of productivity. On the other hand, if the reduction treatment temperature exceeds 1500° C., the precipitated magnetic particles are grown in excess and it may possibly cause agglomeration of the magnetic particles 13 one another. The reduction treatment temperature is more preferably 200 to 1000° C.

In the case where hydrogen is used as the reducing gas, it is preferable to carry out the reduction while the fired layered body 45 is set under hydrogen current flow. If reduction is carried out under hydrogen current flow, the magnetic particles can evenly be precipitated on the entire surface of the second ceramic layer 45 in the fired layered body 46. The flow rate of the hydrogen is not defined definitely but it is preferably, for example, 10 cc/min or higher.

In the fourth process, it is made possible to promote supply of a reducing gas (for example, hydrogen) to the interfaces of the first and second insulating layers 11 and 12 and thereby promote precipitation of the magnetic particles 13 by causing the first insulating layer 11 neighboring the second insulating layer 12 as shown in FIG. 13 to have a porous structure. However, if the first insulating layer 11 is used as it has the porous structure for the antenna substrate production, the long term reliability may possible be deteriorated owing to penetration of water or the like. In such a case, it is preferable to inject and pack an organic resin 47 in the porous first insulating layer 11. By filling the porous first insulating layer 11 with the organic resin 47, the adhesion strength of the porous first insulating layer 11 and the second insulating layer 12 can be increased and the magnetic particles 13 are prevented from dropping off the surface of the second insulating layer 12.

In the fourth process, the reduction treatment may be carried out so as to precipitate the entire amount of the magnetic metal in the second ceramic layer 45 in the fired layered body 46 or the reduction treatment may be carried out so as to leave a portion of the magnetic metal in the ceramic layer 45 remaining in form of, for example, a composite oxide with the metal (M1) in a solid-solution state.

In the fourth process, the formation of the antenna 30 may be carried out by employing a method for laminating a metal sheet of a stainless steel, Cu, Ag, Ni, Au or the like to the layered body 14, a method for applying a paste containing such a metal and drying the paste, or a method for sputtering the metal for forming a film and patterning the film.

In the first to fourth processes, if the first insulating layer 11 in the uppermost layer and the lowest layer of the layered body 14 containing the magnetic particles 13 is formed by firing the first ceramic green sheet 41 containing no compound of the magnetic metal (M2), no magnetic particle is precipitated in the surface of the first insulating layer 11. However, in the case where the first ceramic green sheet 41 is also made to have a composition containing the compound of the magnetic metal (M2) and magnetic particles are precipitated from the first insulating layer in the uppermost and the lowest layers of the layered body, there occurs no problem if the magnetic particles 13 are removed before the antenna formation.

The antenna substrate shown in FIGS. 4 to 8 can be produced by the following method.

1) Method for Manufacturing the Antenna Substrate Shown in FIG. 4

First, ceramic green sheets containing a compound of the metal (M1) and second ceramic green sheets containing a compound of the metal (M1) with different composition from that of the compound of the metal (M1) of the first ceramic green sheets and a compound of the magnetic metal (M2) are respectively formed. A plurality of layers of these first and second ceramic green sheets are reciprocally layered in such a manner that the second ceramic green sheet is in the uppermost layer to manufacture a ceramic green sheet layered body, and the layered body is fired and subjected to reduction treatment. As a result, a layered body 14 is produced in which a first insulating layer 11 containing the oxide of the metal (M1) and a second insulating layer 12 with a composition different from that of the first insulating layer are reciprocally layered and bonded; a plurality of magnetic particles 13 are arranged in the bonded interface of the first and second insulating layers 11 and 12 while being embedded in both of the first and second insulating layers 11 and 12; and a plurality of magnetic particles 13 are arranged in the second insulating layer 12 in the uppermost layer while partly embedded in the second insulating layer 12. Successively, an organic resin layer 15 is formed on the second insulating layer 12 containing the plurality of magnetic particles 13 in the uppermost layer of the layered body 14 to manufacture the antenna substrate shown in FIG. 4.

2) Method for Manufacturing the Antenna Substrate Shown in FIG. 5

A layered body 14 is formed by a similar method to the method described in 1), and an Al thin film or a Si thin film (not shown) is formed by sputtering Al or Si on the surface of the second insulating layer 12 containing the plurality of magnetic particles 13 in the uppermost layer of the layered body 14. Successively, a first heat treatment is carried out to form a solid solution of the Al thin film or the Si thin film with the plurality of magnetic particles 13, and then a second heat treatment (oxidation treatment, nitridation treatment, carbonization treatment) is carried out form a film 16 of Al₂O₃, AlN, SiO₂, Si₃N₄ or SiC on the surface of the second insulating layer 12 out of which the magnetic particles 13 are projected. The first heat treatment is not limited as long as the treatment conditions are proper not to oxidize the magnetic particles and form a solid solution of the particles with Al, Si, or Al—Si, and it is preferably carried out at 200 to 100° C. in an inert gas atmosphere such as Ar. The ratio of the solid solution is determined in consideration of the thickness of the film of Al₂O₃, AlN, SiO₂, Si₃N₄ or SiC to be formed by the second heat treatment (oxidation treatment, nitridation treatment, carbonization treatment) to be carried out thereafter. For example, solid solution of at most 53% of Al with magnetic particles of Fe can be formed. It is possible to form an Al₂O₃ film with a thickness of about 1 nm on the magnetic particle surface by the second heat treatment in oxidizing atmosphere after solid solution of 53% of Al with magnetic particles of Fe with a particle diameter of 10 nm is formed. It is also possible to form an Al₂O₃ film with a thickness of about 5 nm on the surface of the magnetic particles of Fe by the second heat treatment in oxidizing atmosphere after solid solution of 20% of Al with magnetic particles of Fe with a particle diameter of 10 nm is formed.

Next, an organic resin layer 15 is formed on the second insulating layer 12 out of which the plurality of magnetic particles 13 coated with the film 16 of the various compounds are projected to manufacture the antenna substrate 10 shown in FIG. 5.

3) Method of Manufacturing the Antenna Substrate Shown in FIG. 6

A layered body 14 is formed by a similar method to the method described in 1), and an organic resin layer 15 containing a large number of inorganic material particles 17 dispersed therein is formed on the surface of the second insulating layer 12 containing the plurality of magnetic particles 13 in the uppermost layer of the layered body 14 to manufacture the antenna substrate 10 shown in FIG. 6.

4) Method for Manufacturing the Antenna Substrate Shown in FIG. 7

A layered body 14 is formed by a similar method to the method described in 1), and an organic resin layer 15 containing a large number of foams 18 dispersed therein is formed on the surface of the second insulating layer 12 containing the plurality of magnetic particles 13 in the uppermost layer of the layered body 14 to manufacture the antenna substrate 10 shown in FIG. 7.

5) Method for Manufacturing the Antenna Substrate Shown in FIG. 8

Two layered bodies 14 are formed by a similar method to the method described in 1), and these layered bodies 14 are arranged in such a manner that the second insulating layers 12 containing the plurality of magnetic particles 13 embedded therein are set face to face and joined to each other while an organic resin layer 15 is inserted between the layered bodies 14 to manufacture the antenna substrate 10 shown in FIG. 8.

Next, a typical application Example of the antenna device according to the embodiment will be described with reference to the drawings.

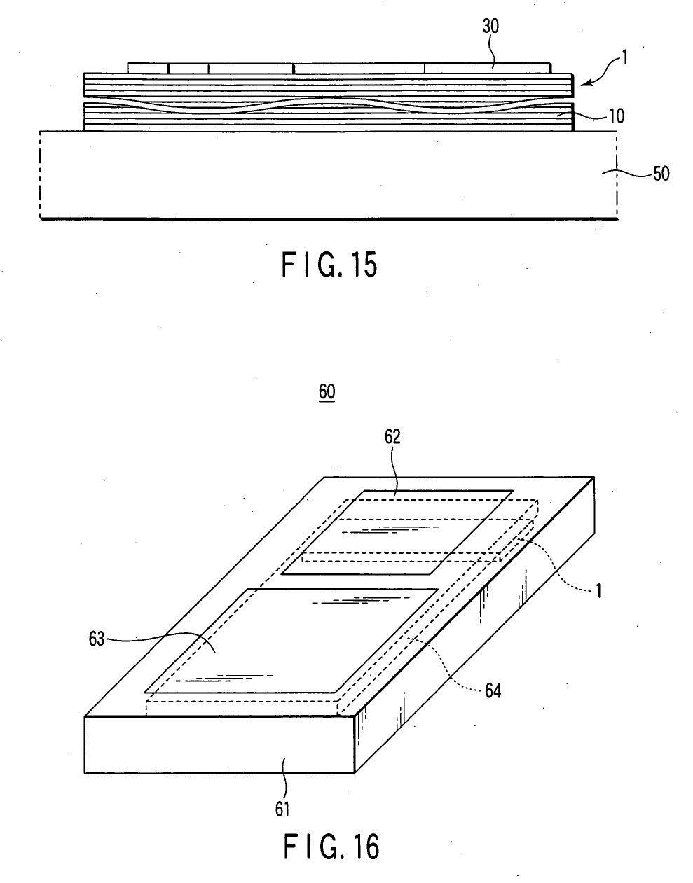

FIG. 15 is a front view showing an electronic circuit board in which the antenna device shown in FIGS. 1 to 3 is assembled. It is preferable that this antenna device 1 be assembled in an electronic circuit board 50 in such a manner that a layer of the plurality of magnetic particles existing in the bonded interface of the first and second insulating layers composing the antenna substrate 10 are arranged approximately parallel to the surface of the electronic circuit board 50. A antenna 30 in the antenna device 1 is connected to the electronic circuit board 50 through a feeder terminal (not shown).

With such a structure shown in FIG. 15, in the case of transmitting and receiving radio waves with a high frequency of 100 MHz to several GHz by means of the antenna 30, absorption of the radio waves in the electronic circuit board 50 positioned in the rear face side of the antenna 30 can be suppressed or prevented, so that it is made possible to carry out transmission and reception at high efficiency.

That is, when the antenna is disposed in the vicinity of the electronic circuit board without the above-mentioned antenna substrate, the radio waves with a high frequency transmitted or received by the antenna is absorbed by the electronic circuit board. Also, because of the absorption of the radio waves by the electronic circuit board, eddy currents are generated and the magnetic field of the eddy currents cancels the magnetic field from the antenna. Accordingly, the absorption of the radio waves by the electronic circuit board is decreased double the radio waves transmitted or received by the antenna.

The antenna substrate 10 according to the embodiment which comprises the layered body 14 formed by layering the plurality of first and second insulating layers 11 and 12, bonding them and embedding the plurality of magnetic particles 13 in the interfaces of the first and second insulating layers 11 and 12 shown in FIGS. 1 to 3, has a high transmission and reception efficiency to radio waves with a high frequency of 100 MHz to several GHz which the antenna transmits or receives. Therefore, the radio waves with a high frequency which the antenna 30 transmits or receives is drawn toward the antenna substrate 10, so that the radio waves are suppressed or prevented from reaching the electronic circuit board 50. In other words, the absorption of the radio waves by the electronic circuit board 50 can be suppressed or prevented. Further, owing to the suppression or prevention of the radio wave absorption by the electronic circuit board 50, eddy current generation in the electronic circuit board 50 and generation of the electric field by the magnetic field of the eddy currents can be suppressed or prevented. Consequently, cancellation of the electric field in the antenna 30 by the electric field can be suppressed or prevented. Accordingly, the antenna device 1 according to the embodiment can suppress or prevent absorption of radio waves which the antenna 30 transmits or receives by the electronic circuit board 50. In addition, the antenna device 1 also can suppress or prevent the cancellation of the electric field of the antenna 30 by the radio wave absorption by the electronic circuit board 50, so that it is made possible to carry out transmission and reception at high efficiency.

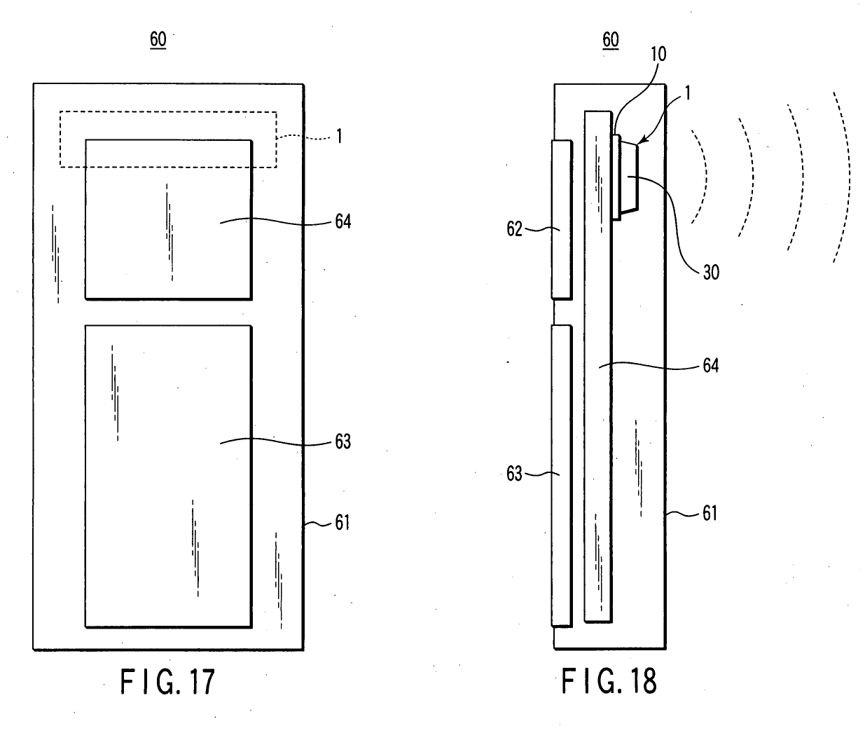

FIG. 16 is a perspective view showing a mobile phone in which the antenna device according to the embodiment shown in FIGS. 1 to 3 is mounted, FIG. 17 is a front view of the mobile phone of FIG. 16, and FIG. 18 is a side view of the mobile phone of FIG. 16.

The mobile phone 60 comprises a casing 61. A liquid crystal display member 62 and an input member 63 are installed in the front face side of the casing 61. An electronic circuit board 64 is arranged in the casing 61 so as to be in the rear face side of the liquid crystal display member 62 and the input member 63. The antenna device 1 according to the embodiment is arranged neighboring to the rear face of the electronic circuit board 64 in the casing 61.

With such a structure, at the time of using the mobile phone 60, the radio waves with a high frequency of 100 MHz to several GHz transmitted or received by the antenna 30 of the antenna device 1 incorporated in the casing 61 can be suppressed or prevented from absorption by the electronic circuit board 64, so that it is made possible to carry out transmission and reception at high efficiency.

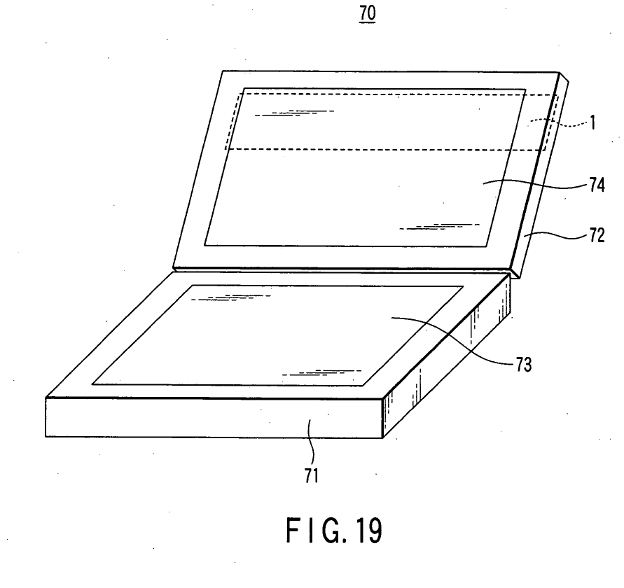

FIG. 19 is a perspective view of a personal computer in which the antenna device according to the embodiment shown in FIGS. 1 to 3 is mounted.

A personal computer 70 comprises a display side casing 72 attached to an input side casing 71 by a hinge mechanism (not shown) in an openable and closable manner. An input member 73 is arranged in the input side casing 71. A display member 74 having an electronic circuit board (not shown) is disposed in the display side casing 72. The antenna device 1 according to the embodiment is disposed in the display side casing 72 so as to be positioned in the rear face side of the display member 74. This antenna device 1 is installed in such a manner that the antenna substrate (not shown) is positioned in the display member 74 side, and the antenna is positioned in the surface of the antenna substrate on the opposite to the display member 74 while keeping the antenna substrate therebetween.

With this structure, at the time of using the personal computer 70, the radio waves with a high frequency of 100 MHz to several GHz transmitted or received by the antenna of the antenna device 1 mounted in the display side casing 72 can be suppressed or prevented from absorption by the electronic circuit board disposed in the display member 74 as described in FIG. 15. As a result, the effect of the radio waves on the display member 74 (comprising the electronic circuit board and the like) side can be suppressed or prevented, so that it is made possible to obtain the personal computer 70 which can carry out a high transmission and reception efficiency.

As described, since radio wave transmission loss can be suppressed by employing the antenna device 1 of the embodiment shown in FIGS. 15 to 19, the antenna device itself can be made in a space-saving manner, and the electronic appliances in which the antenna device is incorporated can be made compact and thin.

Hereinafter, Examples of the invention will be described.

### EXAMPLE 1

First, MgO powder and FeO powder were weighed, mixed by an agitator and preheated at 800° C. for 2 hours in air to obtain a composite oxide powder of (Fe_{0.6}Mg_{0.4})O in which MgO and FeO were completely formed in a solid solution. The composite oxide powder was mixed with acetone, methyl ethyl ketone (MEK), glycerin, polyvinyl butyral (PVB), and dibutyl phthalate (DBP) by a ball mill (for 1 hour at 3000 rpm) to obtain a slurry. The slurry was formed into a sheet by applying the slurry to a 50 μm-thick polyethylene terephthalate (PET) film by a micro gravure coater, and then dried by passing the film in drying regions set at 60° C. and 70° C. to obtain a 1 μm-thick second ceramic green sheet containing 95% by weight of (Fe_{0.6}Mg_{0.4})O powder.

Further, Al₂O₃ powder was formed in a sheet by the same method to obtain a 1 μm-thick first ceramic green sheet containing 90% by weight of Al₂O₃ powder.

<Manufacture of Layered Body>

Next, the first and second ceramic green sheets were separated from the PET films and reciprocally layered to manufacture a ceramic green sheet layered body comprising 603 layers in such a manner that the first ceramic green sheet (the Al₂O₃-containing ceramic green sheet) was in the outermost layer thereof.

The obtained ceramic green sheet layered body was subjected to hydro-isostatic lamination at 240 kg/cm², cut in a predetermined size, and then degreased at 500° C. for 1 hour in Ar atmosphere and further fired at 1300° C. for 1 hour to obtain a layered ceramic plate.

Next, the layered ceramic plate was put in a hydrogen furnace, subjected to reduction treatment at 800° C. for 10 minutes under the condition of circulating hydrogen gas with 99.9% purity at 200 cc/min flow rate, and then cooled in the furnace to obtain an antenna substrate comprising a plurality of Fe nano-particles precipitated in the interfaces of the first insulating layer of Al₂O₃ and the second insulating layer of Fe—Mg—O type composite oxide. Layers of the antenna substrate were separated, and the precipitated Fe particles were observed by a scanning electron microscope (SEM). As a result, numberless Fe particles with 50 to 100 nm were found precipitated while being embedded in the surface of the ceramic. The intervals of the Fe particles were 10 to 30 nm.

Next, an antenna was formed on the surface in one side of the antenna substrate by a printing method using a silver paste to manufacture an antenna device.

### EXAMPLE 2

An antenna substrate was produced and an antenna was formed to manufacture an antenna device in the same manner as in Example 1, except that a first ceramic green sheet containing 90% by weight of Al₂O₃ powder and a second ceramic green sheet containing 95% by weight of (Fe_{0.6}Co_{0.2}Mg_{0.2})O powder were used.

### EXAMPLE 3

An antenna substrate was produced and an antenna was formed to manufacture an antenna device in the same manner as in Example 1, except that a first ceramic green sheet containing 90% by weight of Al₂O₃ powder and a second ceramic green sheet containing 95% by weight of (Fe_{0.5}Co_{0.15}Ni_{0.05}Mg_{0.2})O powder were used.

### EXAMPLE 4

An antenna substrate was produced and an antenna was formed to manufacture an antenna device in the same manner as in Example 1, except that a first ceramic green sheet containing 85% by weight of SiO₂ powder and a second ceramic green sheet containing 95% by weight of (Fe_{0.6}Mg_{0.4})O powder were used.

### EXAMPLE 5

An antenna substrate was produced and an antenna was formed to manufacture an antenna device in the same manner as in Example 1, except that a first ceramic green sheet containing 95% by weight of (Co_{0.3}Al_{0.7})₂O₃ powder and a second ceramic green sheet containing 95% by weight of (Fe_{0.6}Mg_{0.4})O powder were used.

### EXAMPLE 6

An antenna substrate was produced and an antenna was formed to manufacture an antenna device in the same manner as in Example 1, except that a first ceramic green sheet containing 90% by weight of Al₂O₃ powder and a second ceramic green sheet containing 95% by weight of (Fe_{0.6}Mg_{0.4})O+0.01 wt % B₂₀₃ powder were used.

### EXAMPLE 7

Two layered bodies comprising a plurality of Fe nano particles embedded in 200 layers of the interfaces of the first and second insulating layers similar to the layered body of Example 1 were produced. Also, a layered body comprising a plurality of Fe nano particles embedded in 201 layers of the interfaces of the first and second insulating layers similar to the layered body of Example 1 was produced. The layered body with 201 layers had the second insulating layer in which a plurality of Fe nano particles embedded in the outermost layer. Successively, while sandwiching the layered body with 201 layers therebetween, the layered bodies with 200 layers were arranged in such a manner that the second insulating layers in which the Fe nano particles were precipitated of the layered bodies with 200 layers were set to face to the layered body with 201 layers, and bonded and layered by epoxy resin layers with a thickness of 10 μm to manufacture an antenna substrate with 603 layers. Thereafter, an antenna was formed in the antenna substrate in the same manner as in Example 1 to manufacture an antenna device.

### EXAMPLE 8

A layered body with 603 layers comprising a plurality of Fe nano particles embedded in 201 layers of the interfaces of the first and second insulating layers similar to the layered body of Example 1 was dip-coated with an urethane resin solution to manufacture an antenna substrate whose outer circumferential face was coated with a 100 μm-thick urethane resin layer. Thereafter, a copper foil (antenna) was stuck to the antenna substrate to manufacture an antenna device.

### EXAMPLE 9

A box type epoxy resin spacer with a thickness of 0.3 mm and a height of 1 mm opened in the lower part was attached to an antenna substrate similar to the antenna substrate of Example 1, and a copper foil (antenna) was stuck to the spacer to manufacture an antenna device.

The precipitated particles (magnetic particles) of Examples 2 to 5 and 7 to 9 were not so much different from those of Example 1. The precipitated particles (magnetic particles) of Example 6 had a particle size of 10 to 30 nm and the particle intervals of 10 to 30 nm.

### EXAMPLE 10

A needle-like solid solution powder (Fe_{0.7}Mg_{0.3}) with an average diameter of 100 nm and an average length of 1 μm, a spherical solid solution powder (Fe_{0.7}Mg_{0.3}) with an average particle diameter of 50 nm were mixed with acetone, methylethylketone (MEK), glycerin, polyvinylbutyral (PVB), and dibutylphthalate (DBP) by a ball mill (10 minutes, 60 rpm) to obtain a slurry. The obtained slurry was formed into a sheet on a 50 μM-thick polyethylene terephthalate (PET) film by a micro-gravure coater and dried by being passed through drying regions set at 60° C. and 70° C. to obtain a 1 μm-thick second ceramic green sheet containing 95% by weight of (Fe_{0.7}Mg_{0.3})O powder.

Also, Al₂O₃ powder was formed into a sheet in the same manner to obtain a 1 μm-thick first ceramic green sheet containing 90% by weight of Al₂O₃ powder.

<Production of Layered Body>

Next, while being separated from the PET films, the first and the second ceramic green sheets were reciprocally layered in such a manner that the first ceramic green sheet (the ceramic green sheet containing Al₂O₃) was arranged in the outermost layer to obtain a ceramic green sheet layered body comprising 603 layers.

The obtained ceramic green sheet layered body was hydroisostatically laminated at 240 kg/cm² and cut into a prescribed size, after which the cut piece was degreased at 500° C. for 1 hour in an Ar atmosphere and fired at 1300° C. for 1 hour to produce a laminated ceramic plate.

Layers were separated from the laminated ceramic plate and observed by a scanning electron microscope (SEM) to find that the second insulating layer containing Fe—Mg—O type composite oxide had a structure of needle-like particles oriented in one direction parallel to the longitudinal direction of the layer. In addition, according to the results of structural analysis by an x-ray diffractometry, the longitudinal direction of the needle-like particles was found orienting in the [001] direction. The orientation degree was evaluated on the basis of the peak intensity ratio of the (001) plane and other plane to find that the orientation degree was 90% or higher.

Next, the layered ceramic plate was put in a hydrogen furnace and reduced at 850° C. for 10 minutes by circulating hydrogen gas with 99.9% purity at 200 cc/min and then cooled in the furnace to obtain a substrate in which a plurality of Fe nano-particles were precipitated in the interfaces of the first insulating layers of Al₂O₃ and the second insulating layers of Fe—Mg—O type composite oxide and in the layers of Fe—Mg—O type composite oxide. The layers of the substrate were separated and the precipitated Fe particles were observed by a scanning electron microscope (SEM). As a result, numberless Fe particles with a size of 10 to 20 nm were precipitated in the ceramic surface and in the inside. The intervals of the Fe particles including the insides of the particles were 5 to 10 nm.

Further, the orientation property of the Fe particles in the parallel direction and the vertical direction to the layer was evaluated by x-ray diffractometry using the separated sample. As a result, the [100] direction of the Fe particles and the Fe—Mg—O type composite oxides was oriented in the direction vertically to layer and the [001] direction of the Fe particles and the Fe—Mg—O type composite oxides was oriented in the direction parallel to the layer and thus it was found that the sample had a uniaxial anisotropy. The orientation degree of the Fe particles was evaluated to find that the orientation degree was 90% or higher.

Next, the antenna substrate was arranged in such a manner that the [100] direction was at right angles to the magnetic field direction and an antenna was formed to produce an antenna device.

### COMPARATIVE EXAMPLE 1

An antenna device was produced in the same manner as in Example 1, except that a MgO ceramic substrate was used in place of the antenna substrate of Example 1.

### COMPARATIVE EXAMPLE 2

An antenna device was produced in the same manner as in Example 1, except that a magnetic member comprising iron fine particles dispersed in an epoxy resin was used in place of the antenna substrate of Example 1.

### COMPARATIVE EXAMPLE 3

An antenna device was produced in the same manner as in Example 1, except that a NiZn ferrite sintered body was used in place of the antenna substrate of Example 1.

The antenna devices of Examples 1 to 10 and Comparative Examples 1 to 3 were mounted in mobile phones as shown in FIGS. 16 to 18, and the radiation electromagnetic field was measured by the following method.

<Measurement of Radiation Electromagnetic Field>

The reception level of vertically polarized wave of a reception antenna disposed at a position 3 m apart from each mobile phone was measured when radio wave transmitted in a radio dark room. In this case, a phantom was disposed in the side where the mobile phone to be set toward the human body, the coordinates were set as that the phantom side was 0 to 180° and the opposed side to the phantom was 180 to 360°, and the level (reception level) measurement of the radiation electromagnetic wave at 1.8 GHz was carried out. The gain improvement at 270° relative to the standard of the value of Comparative Example 1 was calculated.

The results are shown in the following Table 1.

TABLE 1

| | Gain | | | | | | | | |
|---|---|---|---|---|---|---|---|---|---|
| | improvement | Measurement point and reception level (dBm) | | | | | | | |
| | (dB) | 0° | 45° | 90° | 135° | 180° | 225° | 270° | 315° |
| Example 1 | 5.8 | −16.1 | −23.4 | −37.8 | −46.0 | −21.4 | −12.3 | −9.2 | −11.4 |
| Example 2 | 6.4 | −16.0 | −22.9 | −38.9 | −47.1 | −21.2 | −12.0 | −8.6 | −11.1 |
| Example 3 | 6.1 | −16.2 | −23.7 | −38.7 | −46.8 | −21.2 | −12.2 | −8.9 | −11.3 |
| Example 4 | 5.9 | −16.1 | −23.3 | −37.9 | −45.9 | −21.3 | −12.1 | −9.1 | −11.2 |
| Example 5 | 5.8 | −16.3 | −23.1 | −38.0 | −45.5 | −21.1 | −12.3 | −9.2 | −11.3 |
| Example 6 | 6.2 | −16.1 | −23.7 | −38.2 | −47.0 | −21.2 | −12.1 | −8.8 | −11.2 |
| Example 7 | 5.1 | −16.5 | −23.2 | −38.1 | −46.4 | −21.2 | −12.8 | −9.9 | −11.9 |
| Example 8 | 5.3 | −16.6 | −23.3 | −37.9 | −46.5 | −21.2 | −12.9 | −9.7 | −12.0 |
| Example 9 | 5.5 | −16.7 | −23.3 | −37.9 | −45.9 | −21.5 | −12.4 | −9.5 | −11.5 |
| Example 10 | 6.5 | −16.0 | −22.8 | −38.9 | −47.2 | −21.4 | −12.0 | −8.5 | −11.1 |
| Comparative | 0.0 | −16.8 | −22.4 | −29.7 | −38.0 | −22.0 | −18.1 | −15.0 | −16.7 |
| Example 1 | | | | | | | | | |
| Comparative | 3.7 | −16.6 | −23.9 | −34.1 | −42.0 | −21.9 | −14.5 | −11.3 | −12.8 |
| Example 2 | | | | | | | | | |
| Comparative | 2.4 | −16.6 | −23.8 | −38.0 | −45.5 | −21.1 | −15.7 | −12.6 | −15.5 |
| Example 3 | | | | | | | | | |

As being made clear from Table 1, the antenna devices of Examples 1 to 10 were found having high reception levels in the opposed side in a region of 180° to 360° (0°) to the human being as compared with those of Comparative Examples 1 to 3. The reception level (gain improvement) at 270° was found to be 5 dB or higher improvement in the case of the antenna devices of Examples 1 to 10 from the standard of the level of the antenna device of Comparative Example 1. Further, the antenna devices of Examples 1 to 10 were found having improved reception levels of 1 dB or higher as compared with those of the antenna devices of Comparative Examples 2 and 3.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An antenna device comprising:
an antenna substrate comprising a plurality of insulating layers mutually layered and bonded, and a plurality of magnetic particles arranged in bonded interfaces of the insulating layers and being embedded in both of the insulating layers of the bonded interfaces; and
an antenna arranged directly or in the vicinity of the surface of the antenna substrate.

2. The antenna device according to claim 1, wherein the plurality of insulating layers are ceramic layers having different compositions between neighboring layers, each of ceramic layers containing an oxide of at least one metal selected from the group consisting of Mg, Al, Si, Ca, Cr, Ti, Zr, Ba, Sr, Zn, Mn, Hf and rare earth metals (including Y).

3. The antenna device according to claim 1, wherein the plurality of insulating layers are ceramic layers having different compositions between neighboring layers, each of ceramic layers containing an oxide of at least one metal selected from the group consisting of Mg, Al, Si, Ca, Cr, Ti, Zr, Ba, Sr, Zn, Mn, Hf and rare earth metals (including Y) and an oxide of a magnetic metal.

4. The antenna device according to claim 1, wherein one of the plurality of insulating layers is a ceramic layer containing an oxide of at least one metal selected from the group consisting of Mg, Al, Si, Ca, Cr, Ti, Zr, Ba, Sr, Zn, Mn, Hf and rare earth metals (including Y), the remaining layers are ceramic layers containing an oxide of at least one metal selected from the group consisting of Mg, Al, Si, Ca, Cr, Ti, Zr, Ba, Sr, Zn, Mn, Hf and rare earth metals (including Y) and an oxide of a magnetic metal, and the plurality of insulating layers are ceramic layers having different compositions between neighboring layers.

5. The antenna device according to claim 3, wherein the ceramic layers containing the oxide of the metal and the oxide of the magnetic metal are contained in form of a composite oxide in which the oxide of the metal and the oxide of the magnetic metal are in a solid-solution phase.

6. The antenna device according to claim 1, wherein a layer in the outer-most surface of the plurality of insulating layers is an organic resin layer, and the remaining layers of the plurality of insulating layers are ceramic layers having different compositions between neighboring layers, each of the ceramic layers containing an oxide of at least one metal selected from the group consisting of Mg, Al, Si, Ca, Cr, Ti, Zr, Ba, Sr, Zn, Mn, Hf and rare earth metals (including Y).

7. The antenna device according to claim 1, wherein a layer in the middle of the plurality of insulating layers is an organic resin layer, and the remaining layers are ceramic layers having different compositions between neighboring layers, each of the ceramic layers containing an oxide of at least one metal selected from the group consisting of Mg, Al, Si, Ca, Cr, Ti, Zr, Ba, Sr, Zn, Mn, Hf and rare earth metals (including Y).

8. The antenna device according to claim 6, wherein the organic resin layer contains inorganic material particles or foams dispersed therein.

9. The antenna device according to claim 6, wherein the magnetic particles embedded in the organic resin layer are coated with a film made of at least one inorganic material selected from Al₂O₃, AlN, SiO₂, Si₃N₄ and SiC.

10. The antenna device according to claim 1, wherein, the relation: 0.5<α1/α2<2 is satisfied in a temperature range of from 80° C. to 150° C., wherein α1 denotes a thermal expansion coefficient of one of the neighboring insulating layers of said plurality of insulating layers and α2 denotes a thermal expansion coefficient of the other insulating layer.

11. The antenna device according to claim 1, wherein the magnetic particles have crystallinity, and the crystal orientation is parallel in two or more axes to the crystal orientation of particles constituting at least one of the insulating layers in which the magnetic particles are embedded.

12. The antenna device according to claim 11, wherein the insulating layers are constituted an orientated polycrystalline or an oriented single crystal.

13. The antenna device according to claim 11, wherein interfaces of the magnetic particles and the particles constituting the insulating layers are subjected to lattice conformity.

14. The antenna device according to claim 1, wherein the magnetic particles have a particle diameter of from 1 to 100 nm, and are arranged at intervals of 50 nm or narrower from each other in the bonded interfaces of the insulating layers.

15. The antenna device according to claim 1, wherein the insulating layers each comprise a first insulating layer containing an oxide of at least one metal selected from the group consisting of Mg, Al, Si, Ca, Cr, Ti, Zr, Ba, Sr, Zn, Mn, Hf and rare earth metals (including Y) and a second insulating layer containing an oxide of at least one metal different from that of the first insulating layer and selected from the group consisting of Mg, Al, Si, Ca, Cr, Ti, Zr, Ba, Sr, Zn, Mn, Hf and rare earth metals (including Y) and an oxide of a magnetic metal, and
the first and second insulating layers reciprocally layered, and the plurality of magnetic particles having a particle diameter of from 1 to 100 nm are arranged in the bonded interfaces of the first and second insulating layers at intervals of 50 nm or narrower from each other.

16. The antenna device according to claim 1, wherein the antenna substrate has a resin layer formed at the outer-most surface of the layered body.

17. The antenna device according to claim 1, further comprising an organic resin spacer between the antenna substrate and the antenna, the organic resin spacer having an opening to the antenna substrate.

18. A method for manufacturing an antenna device, comprising:
forming first and second ceramic sheets having mutually different compositions, each of the first and second ceramic sheets containing a compound of at least one metal selected from a group consisting of Mg, Al, Si, Ca, Cr, Ti, Zr, Ba, Sr, Zn, Mn, Hf and rare earth metals (including Y), and at least one of the first and second ceramic green sheets containing a compound of a magnetic metal;
reciprocally laminating a plurality of the first and second ceramic green sheets;
firing the laminated first and second green ceramic sheets to produce first and second ceramic layers; and
precipitating the magnetic metal in the interfaces of the first and second ceramic layers from the ceramic layer containing the oxide of the magnetic metal out of the first and second ceramic layers by subjecting the first and second ceramic layers to reduction treatment.

19. The method for manufacturing an antenna device according to claim 18, wherein the ceramic sheet containing the compound of the magnetic metal contains the metal and the magnetic metal in form of a composite oxide.

20. The method for manufacturing an antenna device according to claim 19, wherein the composite oxide contains the oxide of the metal and the oxide of the magnetic metal at a ratio in a range of 1:9 to 9:1 by mole.

21. The method for manufacturing an antenna device according to claim 18, wherein the ceramic sheet containing the compound of the magnetic metal further contains 0.01 to 0.25% by atom of at least one addition metal selected from Al, Cr, Sc, Si, Mn and B, wherein the addition metal is different from the metal contained in the sheet.

22. The method for manufacturing an antenna device according to claim 18, wherein the precipitating is carried out in conditions of 200 to 1500° C. in hydrogen atmosphere.
